(19) United States
(12) Patent Application Publication
(10) Pub. No.: US 2004/0165112 A1
(43) Pub. Date: Aug. 26, 2004

(54) Method of controlling keyboard input in a multifunctional image display

(75) Inventor: Jung-Soo Suh, Suwon-city (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/681,219

(22) Filed: Oct. 9, 2003

(30) Foreign Application Priority Data
Feb. 24, 2003 (KR) 2003-11415

(51) Int. Cl. H04N 11/00; G09G 5/00

(52) U.S. Cl. 348/552; 345/3.2

(57) ABSTRACT

Disclosed is a method for controlling input from a computer keyboard, in non-monitor mode, in a multifunctional image display apparatus having the function of a TV and computer monitor. The disclosed control method includes the steps of sensing commands input via the key input unit, determining output mode of the monitor, displaying the current mode indicator on the monitor according to the output mode of the monitor by communicating with the monitor after recognizing commands from the key input unit, and executing input commands if the output mode of the monitor is a PC mode and canceling input commands if the output mode of the monitor is not a PC mode.

The present application claims the priority of Korean Patent Application No. 2003-11415, filed on Feb. 24, 2003, in the Korean Intellectual Property Office, the disclosure of which is incorporated herein in its entirety by reference.

### BACKGROUND

1. Field of the Invention

The present invention generally relates to a computer keyboard, and more specifically to a method of limiting data input from a keyboard in the modes other than monitor mode in a multifunctional image display having TV and computer monitor functions.

2. Description of the Related Art

Generally, a computer comprises a main unit having a central processing unit, a data input/output unit, a monitor for displaying data processed by the central processing unit, and other peripheral devices such as a keyboard and a mouse for data input so that a computer is able to operate multi-tasking of reading, comparing, and editing documents. Recently, multifunctional image displays are widely used, such as a computer that can display TV signals in which a card-like TV signal receiving apparatus is equipped and a monitor serves as a display. Moreover, a multifunctional display apparatus with functions of LCD TV, PDP, and micro display is also widely used.

Such a multifunctional imaging apparatus has a PC mode and a TV signal receiving mode that can be selectively used, generally using a mode selecting key on the monitor, and the PC mode displays a signal output from the main unit via a D-sub connector and the TV signal receiving mode is defined as a TV viewing mode when broadcasting signals are displayed, by processing TV signals received via antenna. By the inadvertent data input through a keyboard in non-PC mode such as in TV mode, disaster can happen if important files are deleted partially or totally. This can occur because there is no device equipped to offer warning signs against, or control the input through the keyboard in non-PC mode.

A conventional keyboard input controlling apparatus of a computer, which has been suggested to solve the above problem, is shown in FIG. 1. FIG. 1 is a block diagram showing the main part of the “Apparatus and method for setting a computer input prevention mode” disclosed in the Korean Patent Application No. 2001-1655.

The computer input controlling apparatus of KR Patent Application No. 2001-1655 comprises a monitor 10, a main unit 20, and an interface unit 30 for data exchange between the monitor 10 and the main unit 20. The monitor 10 comprises an input control mode setting unit 11 allowing a user to set up input control mode, and a monitor controlling unit 12 for detecting an input control mode setting signal received from the input control mode setting unit 11 and transmitting it to the interface unit 30. The main unit 20 comprises a keyboard 22, a mouse 23, and a main unit controlling unit 21 for controlling key signals input to the main unit 20 via the keyboard 22 and the mouse 23 according to input control mode setting signals received from the monitor controlling unit 12. The input control mode setting unit 11 comprises one or two keys among monitor controlling keys of the monitor 10, and when the monitor controlling key is pressed, the monitor is correspondingly controlled, but when the monitor controlling key is pressed for the predetermined period of time, or more than two monitor controlling keys are pressed simultaneously, the input control mode setting unit 11 is operated.

Moreover, the input control mode setting unit 11 is designed such that the input control mode is repeatedly turn on and off, in turn, as the monitor controlling key is pressed for the predetermined period of time, or more than two monitor control keys are pressed simultaneously.

FIG. 2 shows a flow chart for explaining an operation of the keyboard input controlling unit in computers. The monitor controlling unit 12 determines S41 whether a predetermined signal is output from the input control mode setting unit 11, and if so, sends S42 the signal to the controlling unit 21 of the main unit 20. Then, the controlling unit 21 determines S43 whether the input control mode is set, by checking an input control mode setting flag. Then, as a result of determination in S43, if the input control mode is not set, the input control mode setting flag is set ‘1’ to enter the input control mode S44, and the monitor controlling unit 12 receives the controlling signal, thereby displaying S45 the input control mode on a screen. Also, in order to prevent signals output via the keyboard 22 and the mouse 23 from altering any contents displayed on the screen 10, the main unit 21 blocks data input via the keyboard 22 and the mouse 23 (S46).

Meanwhile, as a result of the determination in S43, if the input control mode is set, the input control mode setting flag is reset to ‘0’ to turn off the input control mode (S47), and the monitor controlling unit 12 receives the controlling signal, thereby removing the displayed input control mode S48. When the input control mode is determined to be set in S43, a currently-assigned operation is performed corresponding to the signal output from the keyboard 22 and the mouse 23 to the main unit 21 (S49).

However, the conventional technology described above has the following two problems. First, in the conventional technology, the input control mode is equipped in the main unit or on the monitor in order to prevent input via a keyboard, so that a user should manually set the mode. When the user forgets to set the control mode, all data might be lost. Secondly, since the user does not check the monitor mode every time he or she presses a key, all data can be also lost by mishandling, especially when a computer system is unstable, or error data is input.

### SUMMARY

The present invention has been made to overcome the above-mentioned problems of the prior art. The main object of the invention is to protect data by automatically blocking key input signals received in non-computer monitor mode.

According to one preferred embodiment of the present invention, there is provided a method of controlling key input in a multifunctional product capable of receiving outside signals, such as a computer including a key input unit, a monitor, and a main unit or TV signal receiving apparatus. The control method comprises the steps of sensing commands input through the key input unit, determining output mode of the monitor, and processing an input command by the main unit according to the output mode of the monitor by communicating with the monitor after sensing command input from the key input unit.

In input command processing, input commands are canceled if the output mode of the monitor is a non-PC mode, while input commands are properly executed if the output mode of the monitor is a PC mode.

Meanwhile, communication between the monitor and the main unit of the computer is preferably performed with an I2C bus/protocol system.

It is more preferable to have a user recognize the current mode by displaying the current mode indicator on the monitor according to the output mode of the monitor.

### BRIEF DESCRIPTION OF THE DRAWINGS

The objects and features of the invention will be apparent from a reading of the following description in conjunction with the accompanying drawings, in which:

FIG. 1 is a block diagram illustrating a conventional computer keyboard input controlling unit;

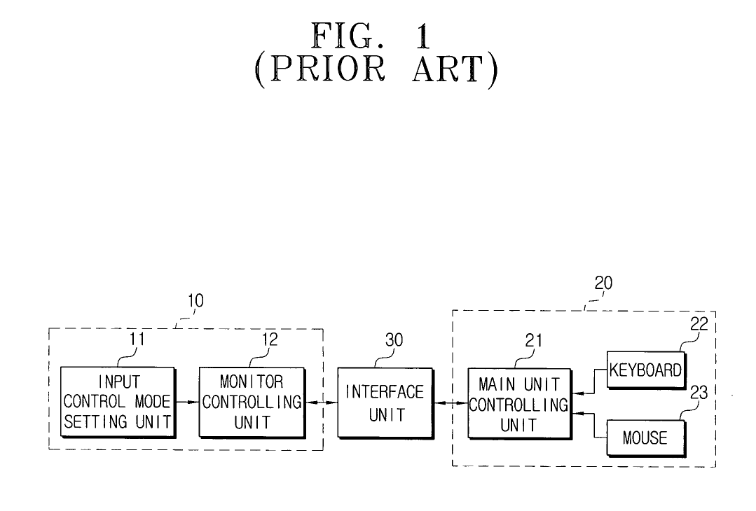

FIG. 2 is a flow chart illustrating the operation of the keyboard input controlling unit of FIG. 1;

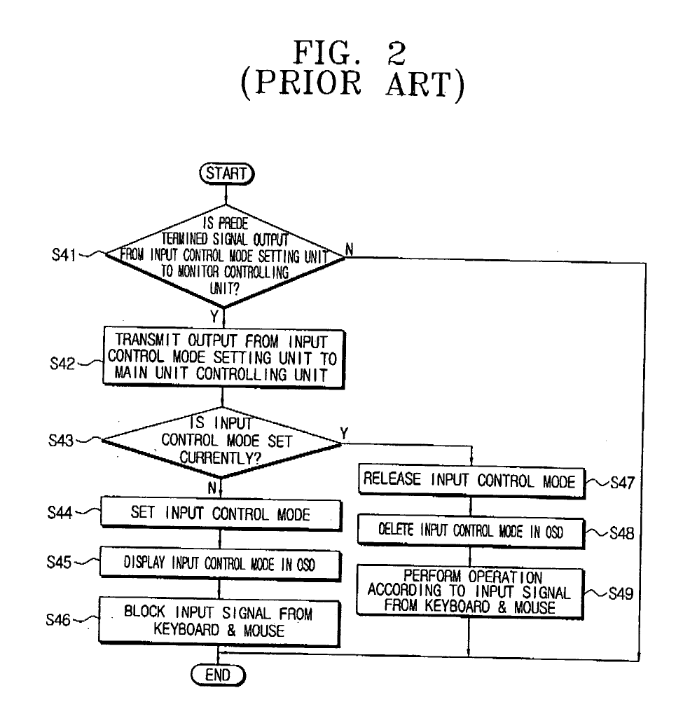

FIG. 3 is a block diagram schematically illustrating the present invention; and

FIG. 4 is a flow chart illustrating an operation of the present invention.

### DESCRIPTION OF THE PREFERRED EMBODIMENT

Hereinafter, at least one aspect of the invention will be described in great detail in conjunction with the drawings attached.

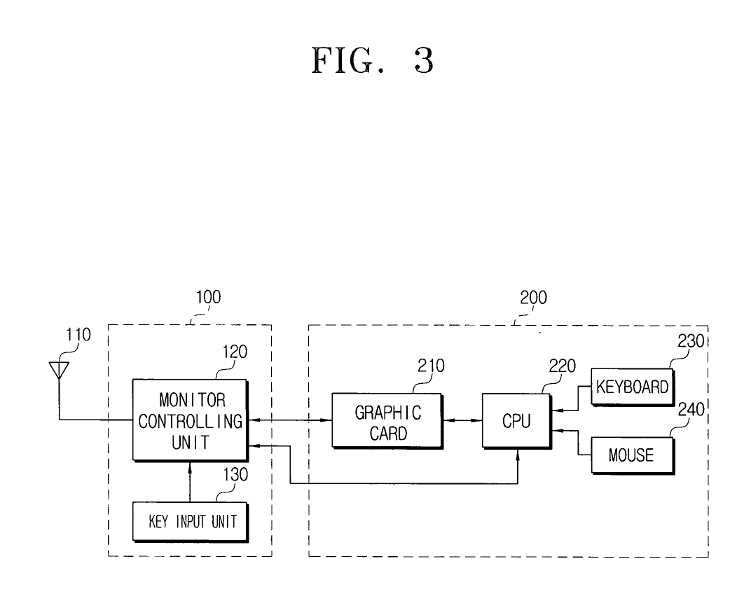

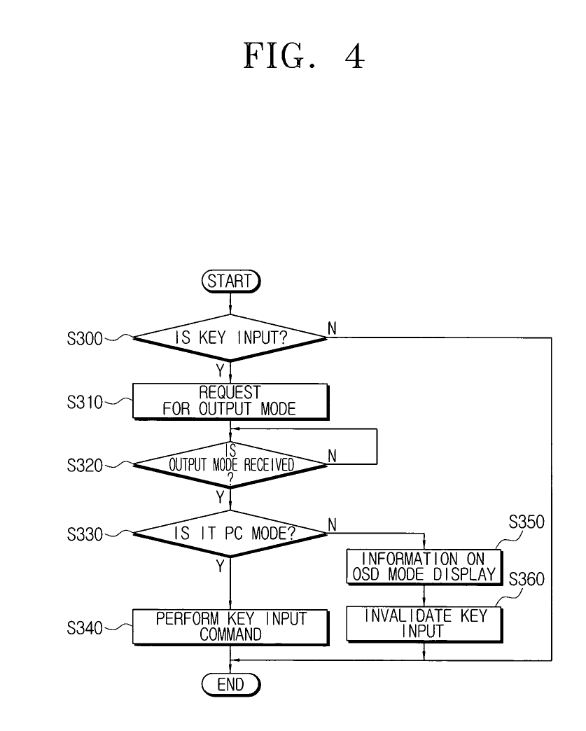

FIG. 3 is a schematic block diagram according to the present invention and FIG. 4 is a flow chart illustrating the operation according to the present invention.

As shown in FIG. []3, a monitor 100 comprises an antenna 110 for receiving TV signals, a key for handling brightness and sharpness of the monitor and other functions, a key input unit 130 wherein mode selecting keys (not shown) are formed for selecting functions for watching TV and receiving signals via the computer main unit 200, and a monitor controlling unit 120 for controlling communication with the computer main unit 200 by processing received TV signals and displaying them on a screen, and for displaying signals received from a PC through a D-SUB cable, on the monitor. If a mode is changed by the mode selecting key, the monitor controlling unit 120 sends mode information to CPU 220. The monitor controlling unit 120 communicates with a graphic card 210 using the D-SUB cable based on the I2C bus/protocol system as a communication protocol. The monitor controlling unit 120 sends various information stored in a DDC (Display Data Channel) chip (not shown) in the monitor 100, such as maximum resolution, manufacturer, serial number, chromaticity, and driver information such as whether it supports DPMS.

The main unit 200 transmits R, G and B signals, horizontal/vertical synchronization, and DDC information. In order to mutually communicate, the DDC 2B protocol is used. The main unit 200 comprises the graphic card 210 for organizing optimum monitor signals according to the information of the monitor driver received via DDD (Display Data Channel) and sending them to the monitor 100, a CPU 220 for opening, analyzing, and editing various documents, and managing key input from peripheral devices according to monitor mode information of the monitor controlling unit 120 while mainly controlling the overall system, and peripheral devices such as a mouse 240 and a keyboard 230. To put it in more detail, the CPU 220 receives information on a monitor mode from the monitor controlling unit 120. The monitor controlling unit 120 determines whether it is TV mode or PC mode and transmits mode data to the CPU 220 whenever the mode changes. If necessary, the CPU 220 can require the monitor controlling unit 120 to send the current mode. Preferably, the monitor controlling unit 120 sends mode controlling flag to the CPU 220 upon receiving mode changing signals from the key input unit 130 via a mode selecting key. The mode selecting flag can be predetermined, for example, as “1”, which means “PC mode” or as “0”, meaning “TV viewing mode”.

When the CPU 220 recognizes data input via the keyboard 230 and the mouse 240, the CPU 220 processes received data related to a mode selecting flag, i.e. data input via the keyboard 230 and the mouse 240 according to the monitor mode. In this case, it is more preferable that the CPU 220 receives the latest mode setting data and processes a key, input by a transmitting signal for requiring a mode of the monitor controlling unit 120, as soon as the CPU receives the key input. Hereinafter, explained in conjunction with FIG. 4 is a method to control keyboard input in a multifunctional image display according to one preferred embodiment of the present invention.

The CPU 220 supervises whether any keys are input via the mouse 240 and the keyboard 230 (S300) and in case of key input, the CPU 220 sends a signal to the monitor to request the output mode so that such information can be sent to a monitor control unit 120 (S310). Although the CPU 220 already memorizes the information of the monitor mode, it is preferable for the CPU 220 to re-send a monitor mode requesting signal to the monitor controlling unit 120 in order to prevent errors, and to receive and process recent data of the current mode.

The CPU 220 determines whether the monitor mode received from the monitor controlling unit 120 (S320) is PC mode or not (S330) and if it is PC mode, the CPU 220 executes key input commands (S340) and if it is not determined to be PC mode in S330, the CPU 220 concludes that the monitor 100 is in TV mode and outputs messages indicating that the monitor's current mode is TV mode, by using the OSD (On Screen Display) (S350). Moreover, the CPU 220 invalidates the key input (S360) and ends the above process. At the step 340, it is preferable to display the current monitor mode to be PC mode on the monitor 100. Moreover, at the step 350, it is more preferable to let a user select a mode by displaying it on the OSD screen, which displays the current monitor mode to be TV mode, validates key input according to the user's instructions, and enables the user to change the monitor mode into PC mode.

According to one preferred embodiment described above, the CPU 220 receives monitor mode information via the monitor controlling unit 120, however, it can be controlled by DDC, USB, IEEE1394, and wireless communication. A brief example provided below is about DDC. DDC is already used for sending and receiving monitor information and monitor signals between the graphic card 210 and the monitor controlling unit 120 through a D-Sub connector and in the preferred embodiment, the monitor controlling unit 120 is operated by a I2C bus line of the D-Sub.

To put it in more detail, the monitor controlling unit 120 stores monitor mode information in an unused address of a DDC chip (not shown) and transmits it to the graphic card 210 upon receiving a mode signal from the graphic card 210. In general, a I2C bus/protocol system comprises a Master IC and Slave ICs, a data line of the Master IC and a Slave IC is interconnected, and clock lines of the two are also interconnected. The Slave ICs have their respective Slave Addresses and the Slave Addresses are used when the Master IC is to communicate with a certain Slave IC. Communication is performed using the graphic card 210 as a Master IC, and the monitor controlling unit 120 as a Slave IC. The monitor control unit 120 stores monitor mode information in a predetermined address of a DDC chip and stays ready to read and transmit data stored in the address upon the receipt of command from the graphic card 210 to send stored data in the address. A detailed explanation of this is omitted due to its similarity to the general I2C bus/protocol system.

In case of key input, the CPU 220 transmits a signal to the graphic card 210, requesting the graphic card 210 monitor mode, and the graphic card 210 sends the received monitor mode to the CPU 220, and data received from the keyboard 230 and the mouse 240 can be processed according to the received monitor mode.

According to the above-described method of controlling keyboard input in multi-functional image displays, data can be protected as keyboard input is automatically blocked even if a user does not set an input control mode, while an input preventing mode setting unit is not equipped in the monitor or the main unit.

Although the invention has been described herein with reference to specific embodiments, many modifications and variations therein will readily occur to those skilled in the art. Accordingly, all such variations and modifications are included within the intended scope of the invention.

What is claimed is:

1. A method of controlling key input in a multifunctional product capable of receiving outside signalssaid multifunctional product having a key input unit, a monitor, and a main unit the method comprising the steps of:
(a) sensing commands input via the key input unit;
(b) determining an output mode of the monitor; and
(c) processing an input command by the main unit according to the output mode of the monitor by communicating with the monitor after sensing the command input from the key input unit.

2. The method of claim 1, wherein the step (c) comprises, if the output mode of the monitor is not a PC mode, canceling input commands.

3. The method of claim 1, wherein the step (c) comprises, if the output mode of the monitor is a PC mode, properly executing input commands.

4. The method of claim 1, further comprising a step of displaying a current mode indicator according to the output mode of the monitor, in the monitor.

5. The method of claim 2, further comprising a step of displaying a current mode indicator according to the output mode of the monitor, in the monitor.

6. The method of claim 1, wherein communication between the monitor and the main unit is performed by at least one of serial and parallel communication.

7. The method of claim 6, wherein the serial communication between the monitor and the computer main unit is performed by a I2C bus/protocol system.

8. The method of claim 1, wherein the multifunctional product is one of a computer and a TV signal receiving apparatus.
